(19) United States
(12) Patent Application Publication
(10) Pub. No.: US 2025/0236130 A1
(43) Pub. Date: Jul. 24, 2025

(54) METHOD AND APPARATUS FOR PRODUCING A TRANSFER MEDIUM, AND TRANSFER MEDIUM

(71) Applicant: RISO KAGAKU CORPORATION, Tokyo (JP)

(72) Inventor: Shoji NARAMOTO, Tokyo (JP)

(73) Assignee: RISO KAGAKU CORPORATION, Tokyo (JP)

(21) Appl. No.: 18/980,152

(22) Filed: Dec. 13, 2024

(30) Foreign Application Priority Data
Jan. 19, 2024 (JP) 2024-006995

(51) Int. Cl. B41M 3/12; B41J 3/44; B41M 5/025; C09J 7/40

(52) U.S. Cl. CPC B41M 3/12; B41J 3/44; B41M 5/0256; C09J 7/403

(57) ABSTRACT

A transfer medium producing apparatus includes a printing unit that receives image data representing a printed image and prints a printed image on a release sheet based on the image data, an adhesive applying unit that applies an adhesive to the release sheet on which the printed image is printed, and a control apparatus which controls the printing unit and the adhesive applying unit. The control apparatus controls the printing unit to add a printed image expansion area that expands outside the periphery of the printed image, and controls the adhesive applying unit such that an adhesive application area is larger than the printed image and smaller than the printed image expansion area.

### CROSS-REFERENCE TO RELATED APPLICATIONS

The present application claims priority under 35 U.S.C. § 119 to Japanese Patent Application No. 2024-006995, filed on Jan. 19, 2024. The above applications are hereby expressly incorporated by reference, in these entireties, into the present application.

### BACKGROUND OF THE INVENTION

### 1. Field of the Invention

The present disclosure is related to an apparatus and a method for producing a transfer medium that transfers a printed image printed on a release sheet to a transfer target medium, and the transfer medium.

### 2. Description of the Related Art

Conventional transfer medium that transfer a printed image printed on a release sheet such as film to a transfer target medium are known.

For example, Japanese Unexamined Patent Publication No. 2013-964 proposes to increase the thickness of an outer coating of an adhesive layer in order to obtain adhesion stability at the periphery of a printed image when producing transfer medium.

In addition, Japanese Unexamined Patent Publication No. 2011-37112 proposes a method of applying an adhesive layer in two stages (exterior and interior) in order to block the flow of an adhesive solution.

Further, Japanese Unexamined Patent Publication No. 2012-200873 proposes setting a coating area of an adhesive layer to be larger than that of an image layer in order to improve abrasion resistance.

### SUMMARY OF THE INVENTION

The methods disclosed in Japanese Unexamined Patent Publication Nos. 2013-964, 2011-37112, and 2012-200873 are methods for improving transfer quality, and the focus point is on the peripheries of images to be transferred.

However, the quality of the transfer is not taken into account when the layers of a printed image to be printed are misaligned with the layers of an adhesive.

If a printed image layer and an adhesive layer are misaligned, a printed image will not be transferred and will be missing in areas where only the printed image is present (an area without adhesive).

In addition, in areas where there is only an adhesive layer (no printed image), a release layer and the adhesive layer of a release sheet will be transferred to a transfer target medium, which will be visually recognized as opaque areas, which are extremely visually obtrusive.

The present disclosure provides a transfer medium producing apparatus and a transfer medium producing method which are capable of producing a transfer medium that achieve high transfer quality by suppressing chipping in a printed image when transferred and by suppressing image quality degradation caused by transfer of unnecessary parts. The present disclosure also provides such a transfer medium.

A transfer medium producing apparatus of the present disclosure is equipped with; a printing unit that accepts image data that represents a printed image and prints the printed image on a release sheet based on the image data, an adhesive applying unit that applies an adhesive to the release sheet on which the printed image is printed, and a control unit that controls the printing unit and the adhesive applying unit, the control unit controlling the printing unit to add a printed image expansion area that expands outside the periphery of the printed image, and controlling the adhesive application unit such that the adhesive application area is larger than the printed image and smaller than the printed image expansion area.

According to the transfer medium producing apparatus of the present disclosure, the printed image expansion area that expands outside the periphery of the printed image is added, and the adhesive application area is larger than the printed image and smaller than the printed image expansion area. Therefore, even if there is a misalignment between the layers of the printed image and the adhesive, chipping in the printed image when the printed image is transferred and deterioration of image quality caused by transfer of unnecessary parts can be suppressed. This enables the production of transfer medium with high transfer quality.

### BRIEF DESCRIPTION OF THE DRAWINGS

FIG. 1 is a schematic diagram that illustrates a transfer medium producing apparatus main body according to one embodiment of the present disclosure.

FIG. 2 is a block diagram that illustrates a control system of the transfer medium producing apparatus main body illustrated in FIG. 1.

FIG. 3 is a cross sectional view of a release sheet according to one embodiment of the present disclosure in the thickness direction thereof.

FIG. 4 is a cross sectional view of a transfer medium according to one embodiment of the present disclosure in the thickness direction thereof.

FIG. 5 is a flowchart for explaining the processes performed by the transfer medium producing apparatus according to one embodiment of the present disclosure.

FIG. 6 is a diagram for explaining a method of transferring a printed image onto a transfer target medium using a transfer medium according to one embodiment of the present disclosure.

FIG. 7 is a diagram that illustrates the manner in which a printed image is transferred in the case of a small misalignment of an adhesive application area with a printed region.

FIG. 8 is a diagram that illustrates the manner in which a printed image is transferred in the case of a large misalignment of an adhesive application area with a printed region.

FIG. 9 is a diagram for explaining an example in which a shear surface is within a printed image expansion area during transfer.

FIG. 10 is a diagram that illustrates an example of transfer medium with a printed image, a printed image expansion area, and a white image are printed on a release sheet.

### DETAILED DESCRIPTION OF THE EMBODIMENTS

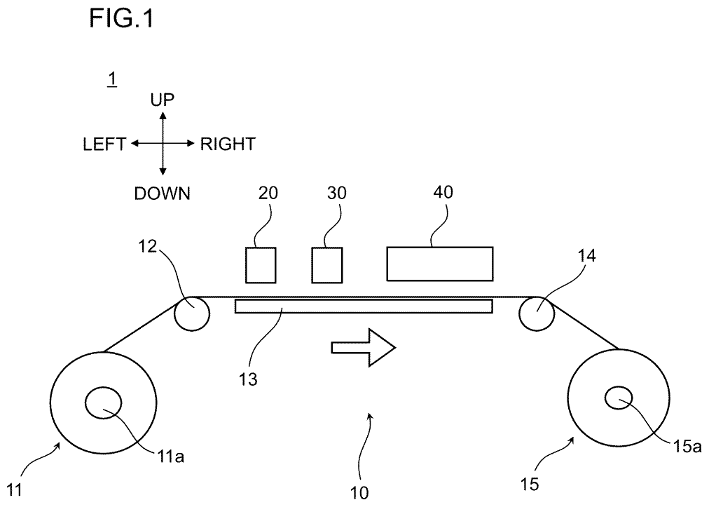

Hereinafter, a transfer medium producing apparatus according to an embodiment of the present disclosure will be described in detail with reference to the attached drawings. The transfer medium producing apparatus of the present embodiment is characterized by a printing area of a transfer medium and an adhesive application area. However, the configuration of the transfer medium producing apparatus main body as a whole will be described first. FIG. 1 is a schematic diagram of a transfer medium producing apparatus main body 1 of the present embodiment. Note that in the present embodiment, the up, down, left, and right directions illustrated in FIG. 1 are the up, down, left, and right directions of the transfer medium producing apparatus main body 1, the direction away from the drawing sheet of FIG. 1 is the front direction of the transfer medium producing apparatus main body 1, and the direction into the drawing sheet is the back direction of the main body transfer medium producing apparatus 1.

The transfer medium producing apparatus main body 1 of the present embodiment is equipped with a release sheet conveying unit 10, a printing unit 20, an adhesive applying unit 30, and a drying unit 40.

The release sheet conveying unit 10 conveys a release sheet and supplies it to the printing unit 20, the adhesive applying unit 30, and the drying unit 40, in this order. The release sheet may be a film, for example. However, but the release sheet may be any material capable of having an image printed thereon and transferring the printed image to a transfer target medium.

The release sheet conveying unit 10 has a release sheet feeding unit 11, a first conveyance roller 12, a platen 13, a second conveyance roller 14, and a release sheet winding unit 15.

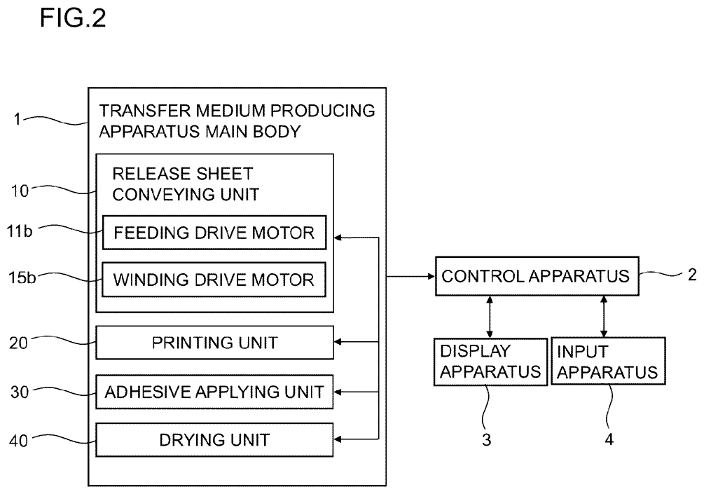

The release sheet feeding unit 11 is provided with a core holding unit 11a on a feeding side that removably holds the core of a roll member on which a release sheet S is wound in the form of a roll. The feeding side core holding unit 11a is connected to a feeding drive motor 11b (refer to FIG. 2) via a torque limiter (not shown). The feeding side core holding unit 11a is configured to be rotated by the feeding drive motor 11b.

The release sheet winding unit 15 has a winding side core holding unit 15a that removably holds a core that winds the release sheet S. The winding side core holding unit 15a is connected to the winding drive motor 15b (refer to FIG. 2) via a torque limiter (not shown). The winding side core holding unit 15a is configured to be rotated by the winding drive motor 15b.

The first conveyance roller 12, the platen 13, and the second conveyance roller 14 are provided between the release sheet feeding unit 11 and the release sheet winding unit 15.

The first and second conveyance rollers 12 and 14 are roller members that extend in the front to back direction and convey the release sheet S which is fed from the release sheet feeding unit 11.

The first conveyance roller 12 is provided upstream of the printing unit 20 in a conveyance direction, and the second conveyance roller 14 is provided downstream of the drying unit 40 in the conveyance direction. The platen 13 is provided between the first conveyance roller 12 and the second conveyance roller 14.

The first conveyance roller 12 and the second conveyance roller 14 are installed such that the peaks of their respective circumferential surfaces are at the same height as the upper surface of the platen 13. Therefore, a configuration in which the back surface of the release sheet S which is conveyed downstream between the first and second conveyance rollers 12 and 14 slides in contact with the top surface of the platen 13 is achieved.

The roll member (release sheet S) held in the feeding side core holding unit 11a is fed by the feeding side core holding unit 11a and the winding side core holding unit 15a rotating. The release sheet S is then wound onto the core held by the winding side core holding unit 15a via the first conveyance roller 12, the platen 13, and the second conveyance roller 14.

The printing unit 20 administers a printing process onto the release sheet S that is conveyed on the platen 13. Specifically, the printing unit 20 is equipped with an inkjet head that discharges ink, and performs printing by discharging ink from the inkjet head onto the release sheet S.

The printing unit 20 is equipped with four inkjet heads, each of which ejects C (cyan), M (magenta), Y (yellow), and K (black) ink, for example. The printing unit 20 may be configured as a so called serial head type, in which printing is performed while moving the four inkjet heads in a direction perpendicular to the conveyance direction of the release sheet S, or as a line head type, in which multiple inkjet heads that eject the ink of the same color are arranged in a direction perpendicular to the conveyance direction to form a line head, for example.

The adhesive applying unit 30 has an inkjet head in the same manner as the printing unit 20, and ejects an adhesive solution instead of ink from the inkjet head to coat the release sheet S on which the printed image has been printed with adhesive. As in the printing unit 20, the adhesive applying unit 30 may be configured as a serial head type or a line head type. By ejecting the adhesive solution from the inkjet head to form an adhesive coated area as in the present embodiment, the adhesive coated area can be formed on any area on the release sheet S.

Any known adhesive solution may be used as the adhesive solution. A solution in which fine capsules having an adhesive agent encapsulated therein are dispersed as disclosed in Japanese Unexamined Patent Publication No. 2011-37014 may be employed, for example. The adhesive solution is ejected onto a printed image from the inkjet heads and adheres thereon in a state in which the capsules are maintained. Then, the capsules are broken during transfer of the printed image by application of heat and pressure, to realize strong adhesive properties.

The drying unit 40 is equipped with a heater, a fan, etc. The drying unit 40 dries the adhesive solution by blowing warm air onto the release sheet S which is coated with the adhesive solution.

Next, FIG. 2 is a block diagram that illustrates the configuration of a control system of the transfer medium producing apparatus. The transfer medium producing apparatus main body 1 illustrated in FIG. 1 operates each of the components illustrated in FIG. 2 which is a target of control based on control signals from a control apparatus 2. Note that in the present embodiment, the control apparatus 2 corresponds to the control unit of the present disclosure.

The control apparatus 2 and the transfer medium producing apparatus main body 1 are connected by a USB (Universal Serial Bus) connection. Alternatively, the control device 2 and the transfer medium producing apparatus main body 1 may be connected via a LAN (Local Area Network) or a communications network such as the Internet.

The control apparatus 2 is constituted by a computer equipped with a CPU (Central Processing Unit), a semiconductor memory, a hard disk, etc. The control device 2 executes a control program which is stored in advance in a recording medium such as a semiconductor memory or a hard disk and operates electric circuits based on image data that that represents an image to be printed, to control each of the components illustrated in FIG. 2.

In particular, the control apparatus 2 controls the printing unit 20 to form a printed image on the release sheet S and controls the adhesive applying unit 30 to apply the adhesive solution on the release sheet S on which the printed image is formed.

The control apparatus 2 of the present embodiment controls the printing unit 20 to add a printed image expansion area that extends from the printed image printed by the printing unit 20, and controls the adhesive applying unit 30 such that the adhesive area coated with the adhesive solution by the adhesive applying unit 30 is larger than the printed image and smaller than the printed image expansion area.

The printed image expansion area is determined by the control apparatus 2 based on the printed image. Specifically, the control apparatus 2 determines the printed image expansion area as an area which is expanded by a preset number of pixels outward from the pixels at the periphery of the printed image, for example. Alternatively, the printed image expansion area may be determined by administering an expansion process to the printed image and subtracting the area of the original printed image from the area of the expansion image. If the printed image is a grid pattern, for example, the printed image expansion area is set for each line that constitutes the grid pattern.

In addition, the control apparatus 2 also determines the adhesive coated area based on the printed image expansion area and the area of the printed image which are determined as described above.

It is preferable for the color of the printed image expansion area to be of substantially the same color as that of the transfer target medium. The expression “substantially the same” includes not only the same color, but also a color similar to the color of the transfer medium. Specifically, it is preferable for a color difference ΔE to be less than 10.

As a method of specifying the color of the printed image expansion area, for example, a user may input settings such as color values (L*a*b* values and RGB values) using an input apparatus 4 which is connected to the control apparatus 2. Another method may be that in which the color values of the transfer target medium employing a scanner or colorimeter, which are not shown in the drawings.

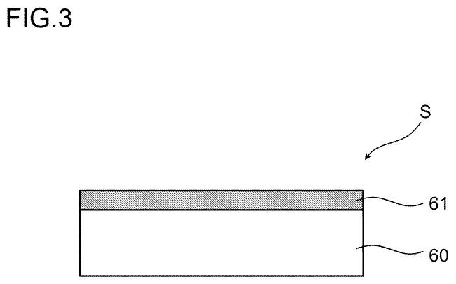

FIG. 3 is a cross sectional diagram of the release sheet S in the thickness direction thereof. The release sheet S has a substrate 60 such as a film, which is coated with a release layer 61 which is peeled off and transferred after having a printed image formed thereon. The release layer 61 is coated with a void type (inorganic microparticles such as silica) or a swelling type (polyvinyl alcohol (PVA) that absorbs ink and swells) as a coating agent such that a color material (pigment or dye) of the ink will color the release layer 61, and a silicone resin as a coating agent to release the ink from the base material.

The printing unit 20 performs printing of the printed image and the printed image expansion area on the release layer 61 of the release sheet S. Then, the adhesive applying unit 30 coats the release layer 61 of the release sheet S to form a layer of the adhesive solution on the printed image and the printed image expansion area.

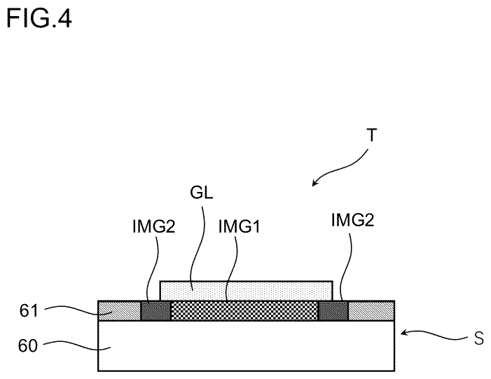

FIG. 4 is a cross sectional diagram of a transfer medium T in the thickness direction thereof. The layer denoted as IMG1 in FIG. 4 is the printed image which is printed on the release sheet S, the areas denoted as IMG2 are the printed image expansion area, and the area denoted as GL is the adhesive application area. As illustrated in FIG. 4, the adhesive application area GL is larger than the printed image IMG1 and smaller than the printed image expansion area IMG2. Note that in the present embodiment, the printed image IMG1 and the printed image expansion area IMG2 are permeated in the release layer 61 of the release sheet S.

If there are multiple images or characters in a printed image, not all of them may be desired to be transferred. Therefore, the user may specify an image to be transferred from within in the printed image.

Specifically, the control apparatus 2 displays a preview of the printed image on a display apparatus 3 which is connected to the control apparatus 2 based on the image data that represents the printed image, for example. Then, the control apparatus 2 receives a designation of an image to be transferred from within the preview printed image and specifies the image to be transferred. Another method is to specify an image to be transferred by the user setting and entering data that designates the image to be transferred using the input apparatus 4 which is connected to the control apparatus 2, for example.

Note that instead of the user specifying the image to be transferred as described above, the control apparatus 2 may specify the image to be transferred by performing pattern recognition of a predetermined image based on the image data that represents the printed image. For example, if a position aligning image of the transfer target medium is included for transferring from the transfer medium to the transfer target medium, the pattern of the position aligning image may be recognized and portions of an image other than the position aligning image may be specified as the image to be transferred, since it is not necessary to transfer the position aligning image.

In addition, the control apparatus 2 also administers various image processes necessary for printing, such as a color conversion process and a halftone process, on the image data that represents the printed image.

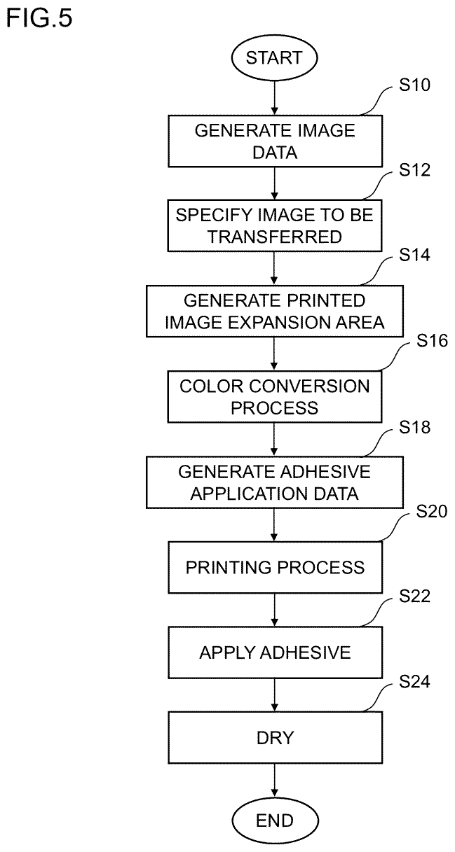

Next, the flow of processes performed by the transfer medium producing apparatus of the present embodiment will be explained with reference to the flowchart illustrated in FIG. 5.

First, image data that represents a printed image is generated by the control apparatus 2 (S10). The image data is generated by a user, for example, using an application installed in the control apparatus 2. However, the present disclosure is not limited to such a configuration, and the control apparatus 2 may also receive image data which is scanned by a scanner connected to the control apparatus 2.

The control apparatus 2 then accepts designation of an image to be transferred by displaying a preview of the printed image on the display apparatus 3 as described above, and specifies the image to be transferred (S12).

The control apparatus 2 then expands the image area to be printed outside the periphery of the specified printed image in the same color as the transfer target medium (printed image expansion area) (S14).

Next, the control apparatus 2 administers a color conversion process on the generated image data in RGB format based on the specified printed image and printed image expansion area to generate image data in CMYK format (S16).

The control apparatus 2 then administers a halftone process on each of the C, M, Y, and K image data to generate ink drop data. The ink drop data in the present embodiment is data that specifies the number of ink drops to be ejected from one nozzle of the inkjet printhead to form one dot in the printed image.

Continuing, the control apparatus 2 then generates adhesive application data based on the information of the printed image area and the printed image expansion area (S18). At this time, the adhesive application area is larger than the printed image and smaller than the printed image expansion area to allow for print position misalignment and to avoid applying the adhesive to unnecessary areas. The tolerance of the print position misalignment will described in detail later.

Similar to the ink drop data, the adhesive application data specifies the number of drops of the adhesive solution to be ejected from one nozzle for one dot of the printed image to be transferred. In the present embodiment, the adhesive application data is generated such that the same amount of adhesive solution is applied to each dot that constitutes the printed image to be transferred.

Then, the control apparatus 2 controls the inkjet heads of each color in the printing unit 20 based on the ink drop data for each color, including both the printed image area and the printed image expansion area, to print the printed image to be transferred and the printed image expansion area on the release sheet S (S20).

Next, the control apparatus 2 controls the adhesive applying unit 30 based on the adhesive application data to apply the adhesive solution such that it is layered on the printed image area and the printed image expansion area on the release sheet S (S22).

The release sheet S which is coated with the adhesive solution is then dried by the drying unit 40 (S24) to produce a transfer medium.

The above is a description of the method for producing a transfer medium.

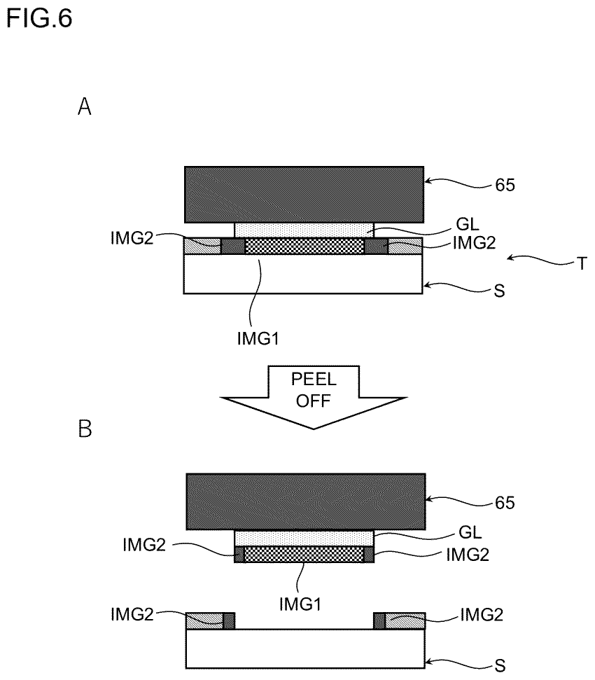

After the transfer medium is produced in the manner described above, a transfer target medium 65 is overlaid on the transfer medium T, pressed and heated as illustrated in FIG. 6A, and then the transfer target medium 65 is peeled off from the transfer medium T as illustrated in FIG. 6B. Thereby, the printed image and the printed image expansion area of the adhesive-applied portion are transferred to the transfer target medium to obtain a printed product.

Note that the type of transfer target medium is not limited, and a variety of materials such as film, fabric, metal, and plastic may be employed.

Next, the print position misalignment that occurs when a printed image on the transfer medium is transferred to the transfer target medium will be described.

First, the print positions of the printed image 62 and the printed image expansion area 63 are almost never misaligned, because they are printed by the printing unit 20 (because they are printed by the same inkjet head).

However, the adhesive application area GL is printed by the adhesive applying unit 30 (printed by the inkjet head for the adhesive solution different from the CMYK inkjet head), and therefore the print position thereof become misaligned with respect to those of the printed image IMG1 and the printed image expansion area IMG2 due to various factors such as the accuracy of the inkjet head and the conveyance accuracy of the release sheet S.

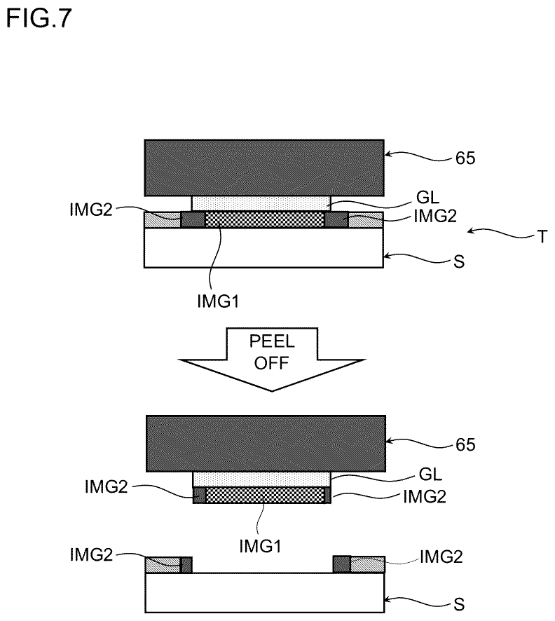

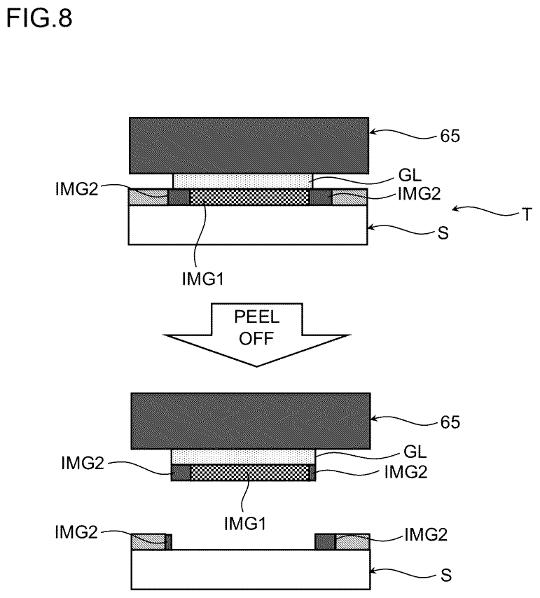

FIG. 7 is a diagram that illustrates the manner in which a printed image is transferred in the case of a small misalignment of an adhesive application area GL with a printed region, and FIG. 8 is a diagram that illustrates the manner in which a printed image is transferred in the case of a large misalignment of an adhesive application area GL with a printed region.

In the present embodiment, a printed image expansion area is formed such that even if misalignment of the print position of the adhesive application area GL with respect to the printed image IMG1 occurs, as illustrated in FIG. 7 and FIG. 8, the adhesive application area is expanded outside the periphery of the printed image and is smaller than the printed image expansion area. Thereby, chipping in the printed image can be prevented.

In addition, by providing the printed image expansion area and setting it to be the same color as that of the transfer target medium, the printed image expansion area can be made less noticeable when transferred onto the transfer target medium. That is, the adhesive application area is larger than the printed image and smaller than the printed image expansion area. Therefore, a degree of allowance is imparted for print position misalignment and the adhesive can be prevented from being coated onto unnecessary areas.

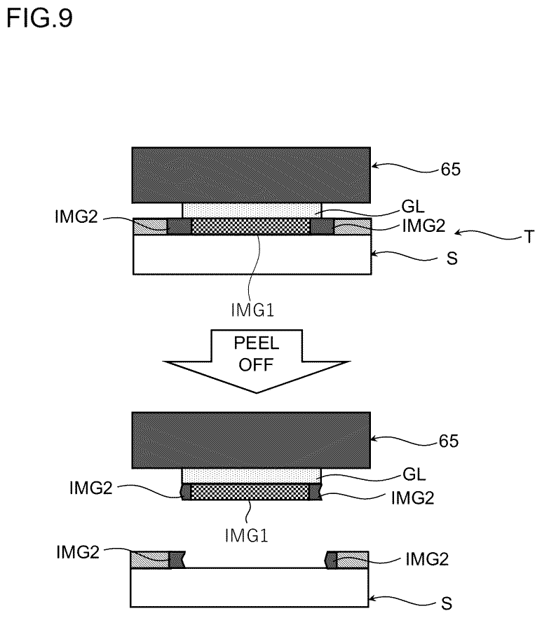

In addition, at the boundary between an area where the adhesive is coated and an area where the adhesive is not coated, sharpness at a shear surface may not be obtained at the time of peeling. However, the printed image expansion area is provided in the present embodiment. Therefore, the sharpness of the shear surface is lost only within the printed image expansion area, and there is no effect on the printed image, as illustrated in FIG. 9.

Note that with respect to the expansion size of the printed image expansion area, the amount of misalignment in print positions (width of misalignment) caused by the mounting positions of and ejection from inkjet heads is considered to be about 1 mm. Particularly in the case that the transfer target medium is a woven fabric which expands and contracts such as a knitted fabric, the transfer accuracy cannot be secured and print positions are likely to be misaligned. Because knitted fabrics expand and contract by about 10% of the size of the fabric, there is a possibility of a misalignment of about 10 mm.

The surface state of transfer target medium is not always flat, but may also include uneven surfaces. For example, woven fabrics (textiles and knitted fabrics) are examples of transfer target medium having uneven surfaces due to the thickness and mesh of the threads. When a transfer medium and such a transfer target medium undergo transfer by pressure bonding, adherence to the concave portions is difficult, causing the transfer to become unstable. Particularly at peripheral portions, it is difficult for shear surfaces to be sharp. To avoid such unstable areas, it is preferable to expand the printed image expansion area by about 5 mm, which is equivalent to two times the pitch of the concave portions.

For the reasons described above, it is preferable for the expansion width of the printed image expansion area to be from about 1 mm to about 10 mm.

In the case that a base color of a transfer target medium is dark, an inkjet head that discharges white ink may be further provided in the printing unit 20 to print a base image to cover up the color of the transfer target medium and ensure the coloring of the printed image as a base treatment.

A printing process that prints a white image with white ink as the base image, will be described below.

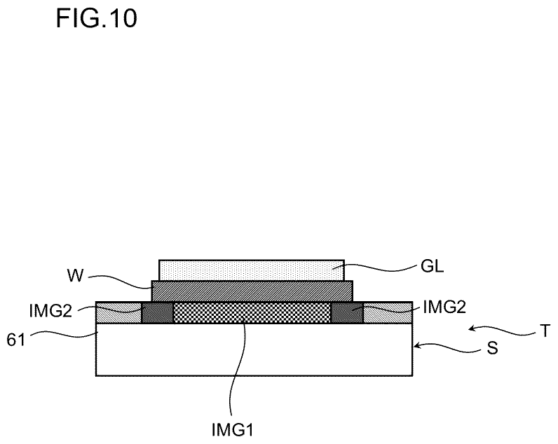

As illustrated in FIG. 10, the printing process for the printed image IMG1, the printed image expansion area IMG2, and a white image W onto the release layer 61 of the release sheet S is performed by the printing unit 20.

Here, the printed image IMG1 is a printed image based on image data, and the white image W is printed onto the same printing area as the printed image IMG1 and an expanded printing area outside the periphery thereof, the entire area of which is printed with white ink.

The printed image expansion area IMG2 is a printed area that is expanded outside the periphery of the printed image IMG1 and is printed in the same color as the transfer target medium 65.

Next, the adhesive application area GL is coated by the adhesive applying unit 30 as a layer on the printed image IMG1, the printed image expansion area IMG2, and the white image W.

At this time, the adhesive application area GL is larger than the printed image IMG1 and smaller than the printed image expansion area IMG2. Further, the relationship among the printed image IMG1, the printed image expansion area IMG2, the adhesive application area GL, and the white image W is:
Adhesive application area GL<White image W<Printed image IMG1+Printed image expansion area IMG2

Note that in the above embodiment, the adhesive layer is formed by applying an adhesive solution employing an inkjet head. However, the adhesive is not limited to an adhesive solution, and the adhesive layer may be formed by sprinkling and applying a hot melt powder instead. A thermoplastic adhesive powder, such as polyurethane (TPU, for example) may be employed as the hot melt powder. In the case that a hot melt powder is employed, an adhesive solution is not employed. Therefore, so there will be no misalignment between the adhesive and the printed image. However, in the case that a white image is printed as described above as a base treatment, misalignment between the white image and the printed image may occur. In addition, whether the adhesive is an adhesive solution or a hot melt powder, a shear surface of the release layer not being sharp when peeling off the transfer medium may occur. Therefore, even in the case that a hot melt powder is employed to form the adhesive layer, it is preferable to provide a printed image expansion area as in the above embodiment.

According to the transfer medium producing apparatus of the above embodiment, the printing unit 20 is controlled to add an extended printed image expansion area to the periphery of a printed image and the adhesive applying unit 30 is controlled such that an adhesive application area is larger than the printed image and smaller than the printed image expansion area. Therefore, even in the case that misalignment between a printed image layer and an adhesive layer occurs, chipping in the printed image when the printed image is transferred and deterioration of image quality due to transfer of unnecessary parts can be suppressed, and a transfer medium that exhibits high transfer quality can be produced.

In addition, an increase in cost associated with improving the accuracy of a printing apparatus to reduce misalignments in printing position can be obviated. Further, because the influence of misalignment in printing positions is reduced, it will become possible to expand the range of utilization to transfer target medium (e.g., stretchable materials such as knitted fabrics), for which conveyance accuracy is difficult to obtain.

Further, in the transfer medium producing apparatus of the above embodiment, the color of the printed image expansion area is set to be approximately the same color as that of the transfer target medium. Therefore, even if part of the printed image expansion area is transferred onto the transfer target medium, such a transferred area can be made less noticeable.

In the transfer medium producing apparatus of the above embodiment, a white image is printed between the printed image and the adhesive layer, and the range of the white image is larger than the printed image and smaller than the printed image expansion area, such that even if a print position misalignment occurs between the printed image and the white image, the white image can be prevented from being transferred beyond the edge of the print image and becoming conspicuous.

Note that the present disclosure is not limited to the above embodiments, but may be realized by modifying the components to an extent that it does not depart from the spirit thereof at the implementation stage. Also, various inventions may be formed by appropriate combinations of the plurality of components disclosed in the above embodiments. For example, all of the components described in the embodiments may be combined as appropriate. It is, of course, possible to make various modifications and applications within the scope that does not depart from the spirit of the disclosure.

The following additional items are further disclosed with respect to the present disclosure.
(Item 1)

A transfer medium producing apparatus of the present disclosure is equipped with; a printing unit that accepts image data that represents a printed image and prints the printed image on a release sheet based on the image data, an adhesive applying unit that applies an adhesive to the release sheet on which the printed image is printed, and a control unit that controls the printing unit and the adhesive applying unit, the control unit controlling the printing unit to add a printed image expansion area that expands outside the periphery of the printed image, and controlling the adhesive application unit such that the adhesive application area is larger than the printed image and smaller than the printed image expansion area.
(Item 2)

In the transfer medium producing apparatus according to Item 1, it is preferable for the color of the printed image expansion area to be the same color as that of a transfer target medium.
(Item 3)

In the transfer medium producing apparatus according to Item 1 or Item 2, the printing unit may print a base image between the printed image and a layer of the adhesive, and the area of the base image may be larger than the printed image and smaller than the printed image expansion area.
(Item 4)

A method for producing a transfer medium of the present disclosure receives image data that represents a printed image, prints a printed image on a release sheet based on the image data, and applies an adhesive to the release sheet on which the printed image is printed, a printed image expansion area that expands outside the periphery of the printed image being added, and an area where the adhesive is applied being larger than the printed image and smaller than the printed image expansion area.

### (Item 5)

A transfer medium of the present disclosure is a transfer medium which is equipped with a release sheet on which a printed image is printed and an adhesive layer, to which a printed image expansion area that expands outside the periphery of the printed image is added, the adhesive layer being larger than the printed image and smaller than the printed image expansion area.

What is claimed is:

1. A transfer medium producing apparatus comprising;
a printing unit that accepts image data that represents a printed image and prints the printed image on a release sheet based on the image data;
an adhesive applying unit that applies an adhesive to the release sheet on which the printed image is printed; and
a control unit that controls the printing unit and the adhesive applying unit;
the control unit controlling the printing unit to add a printed image expansion area that expands outside the periphery of the printed image, and controlling the adhesive application unit such that an area onto which the adhesive is applied is larger than the printed image and smaller than the printed image expansion area.

2. The transfer medium producing apparatus according to claim 1, wherein:
the color of the printed image expansion area is the same color as that of a transfer target medium.

3. The transfer medium producing apparatus according to claim 1, wherein:
the printing unit prints a base image between the printed image and a layer of the adhesive; and
the area of the base image is larger than the printed image and smaller than the printed image expansion area.

4. The transfer medium producing apparatus according to claim 2, wherein:
the printing unit prints a base image between the printed image and a layer of the adhesive; and
the area of the base image is larger than the printed image and smaller than the printed image expansion area.

5. A method for producing a transfer medium, comprising:
receiving image data that represents a printed image;
printing a printed image on a release sheet based on the image data; and
applying an adhesive to the release sheet on which the printed image is printed;
a printed image expansion area that expands outside the periphery of the printed image being added; and
an area where the adhesive is applied being larger than the printed image and smaller than the printed image expansion area.

6. A transfer medium comprising:
a release sheet on which a printed image is printed; and
an adhesive layer;
a printed image expansion area that expands outside the periphery of the printed image being added; and
the adhesive layer being larger than the printed image and smaller than the printed image expansion area.
